(19) United States
(12) Patent Application Publication
(10) Pub. No.: US 2010/0124581 A1
(43) Pub. Date: May 20, 2010

(54) INJECTION MOLD WITH WORKPIECE TRIMMING EDGE

(75) Inventor: HSIEH-TING HUANG, Miao-Li County (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP., Miao-Li County (TW)

(21) Appl. No.: 12/607,171

(22) Filed: Oct. 28, 2009

(30) Foreign Application Priority Data
Nov. 14, 2008 (CN) 200810217821.5

(51) Int. Cl. B29C 45/42; B29C 45/40

(52) U.S. Cl. 425/556

(57) ABSTRACT

An injection mold includes a movable half. The movable half includes a gate, a first cavity surface communicating with the gate and a knockout pin. The gate is a channel having an opening. The first cavity surface is adjoining the gate at the opening. The knockout pin is oblique to a moving direction of the movable half. The knockout pin extends towards the first cavity surface and adjacent to the opening of the gate. The knockout pin includes a trimming edge coplanar with the opening of the gate and the first cavity surface.

### BACKGROUND

1. Technical Field

The present disclosure generally relates to injection molds and, particularly, to an injection mold with a knockout pin having a trimming edge.

2. Description of Related Art

Injection molding has advantages of low cost, short molding time, simplicity, and ease of forming products with irregular, complex shapes. Injection molds are popular in many manufacturing industries.

Referring to FIG. 6, a frequently used injection mold 10 is shown. The injection mold 10 includes a fixed half 11, a movable half 12, a mold base 13, and an ejector mechanism 14. The mold base 13 supports the fixed half 11, the movable half 12 and the ejector mechanism 14. The fixed half 11 includes a fixed mold 111, and the movable half 12 includes a movable mold 121. When clamping the injection mold 10, the movable half 12 is coupled to the fixed half 11, and thus a cavity 151 is formed by the fixed mold 111 and the movable mold 121. The ejector mechanism 14 includes an ejector retention plate 141 and a plurality of ejector pins 142. The ejector pins 142 are fixed to the ejector retention plate 141 and moved by the ejector retention plate 141. To ensure evenness of a surface of the injection molded product, the injection mold 10 includes a gate 152 parallel to the ejector direction and a runner 153 connecting to the gate 152 and admitting molten material therethrough.

Referring also to FIG. 7, during unclamping of the injection mold 10, the movable half 12 is separated from the fixed half 11. The injection molded product and unwanted portions formed in the gate 152 are ejected by the ejector pins 142 driven by the ejector retention plate 141.

Typically, the excess material formed in the gate 152, i.e., the unwanted portions, is removed manually or by machine. This costs manpower or machine power, and extends the manufacturing time and elevates the cost of the product.

Therefore, an injection mold that can overcome the described limitations is desired.

### BRIEF DESCRIPTION OF THE DRAWINGS

The components in the drawings are not necessarily drawn to scale, the emphasis instead being placed upon clearly illustrating the principles of the frequently used injection mold and the injection mold of embodiments of the present invention. Moreover, in the drawings, like reference numerals designate corresponding parts throughout the several views, and all the views are schematic.

FIG. 1 is a cross-section of a first embodiment of an injection mold, shown in a clamped state, and showing a molded product in the injection mold.

FIG. 2 is an enlarged view of a region II of the injection mold of FIG. 1.

FIG. 3 is similar to FIG. 1, but showing the injection mold in a separated state.

FIG. 4 is a series of views showing a process of the injection mold of FIG. 1 trimming excess material formed in a gate of the injection mold during molding of a product.

FIG. 5 is similar to FIG. 2, but showing parts of a second embodiment of an injection mold, and showing a molded product in the injection mold.

FIG. 6 is a cross-section of a frequently used injection mold, shown in a clamped state.

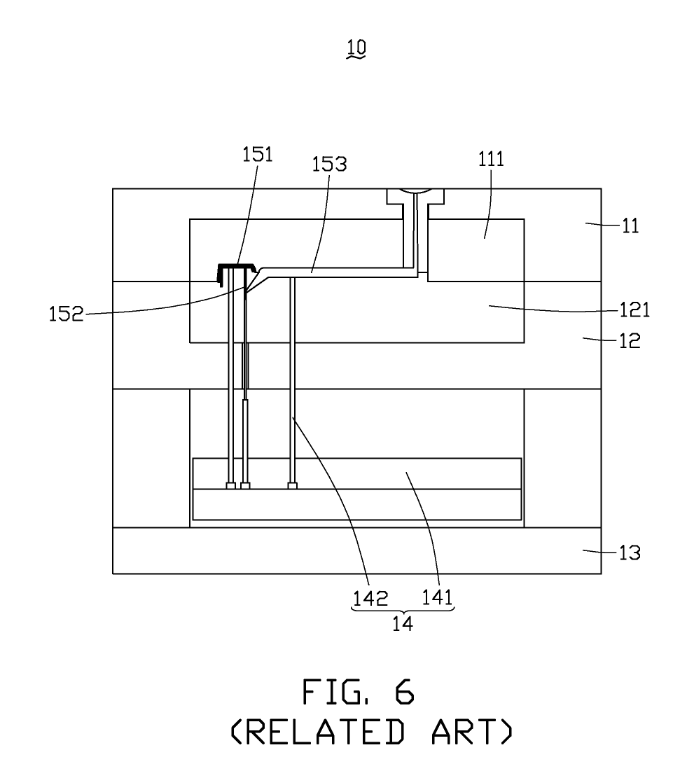

FIG. 7 is similar to FIG. 6, but showing the injection mold in a separated state.

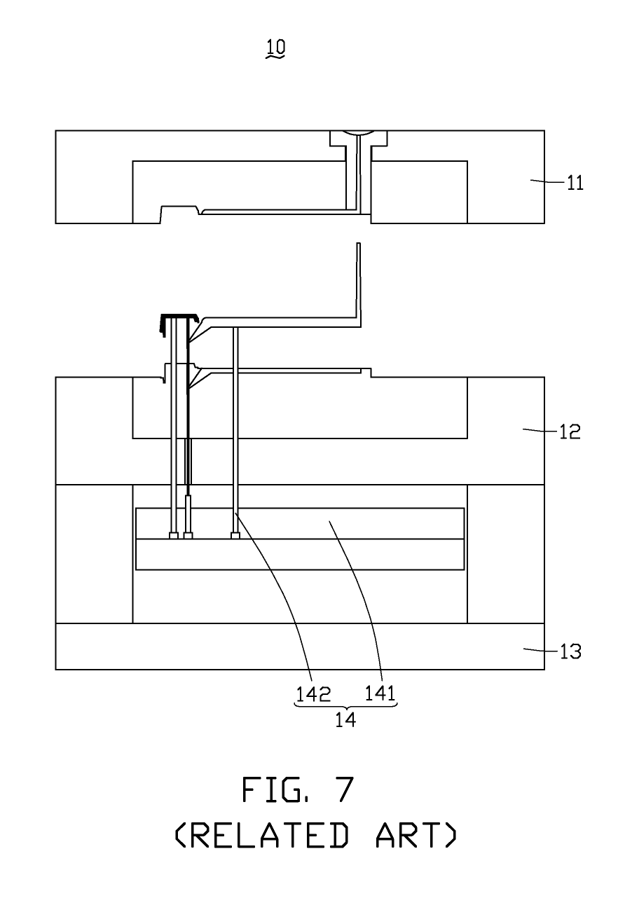

### DETAILED DESCRIPTION

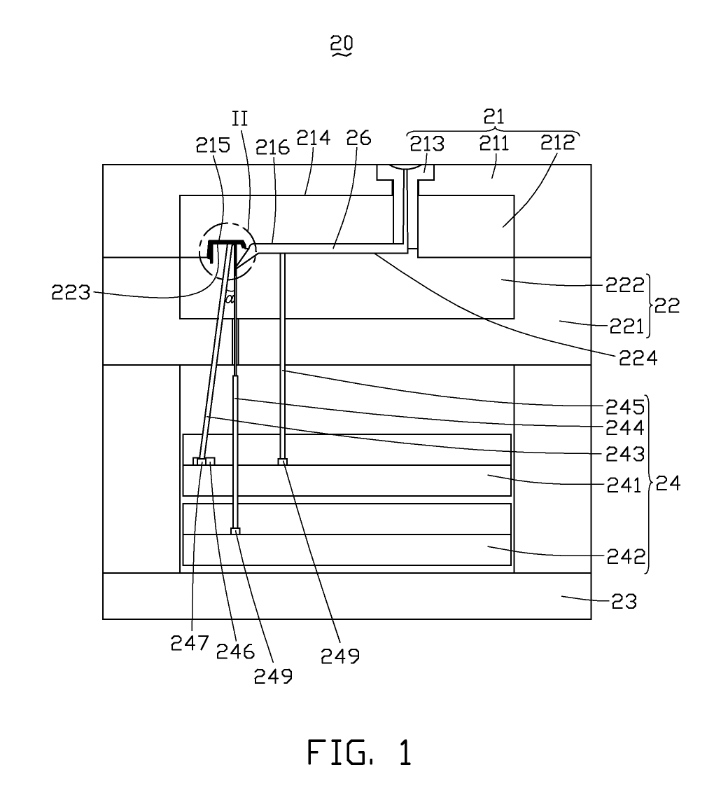

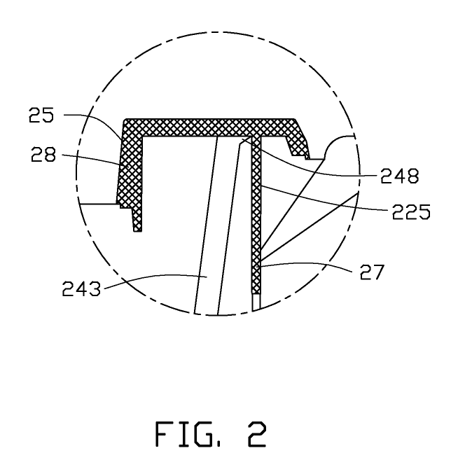

Referring to FIG. 1 and FIG. 2, a first embodiment of an injection mold 20 is shown. The injection mold 20 includes a fixed half 21, a movable half 22, a mold base 23, and an ejector mechanism 24. The mold base 23 supports the fixed half 21, the movable half 22 and the ejector mechanism 24. The fixed half 21 and the movable half 22 cooperatively form a cavity 25. The ejector mechanism 24 is disposed between the fixed half 21 and the movable half 22.

The fixed half 21 includes a fixed plate 211, a fixed mold 212, and an injection system 213. The fixed plate 211 includes a receptacle 214 to receive the fixed mold 212. The fixed mold 212 includes a molding surface (not labeled) facing the movable half 22, and the molding surface includes a first cavity surface 215 and a first runner surface 216. The injection system 213 runs through the fixed plate 211 and the fixed mold 212, and communicates with the first runner surface 216.

The movable half 22 includes a movable plate 221, and a movable mold 222 received in the movable plate 221. The movable mold 222 includes a second cavity surface 223, a second runner surface 224, and a gate 225. The first cavity surface 215 and the second cavity surface 223 cooperatively form the cavity 25, and the first runner surface 216 and the second runner surface 224 cooperatively form a runner 26. The runner 26 communicates with the injection system 213. The gate 225 is a channel extending from the second cavity surface 223 to the interior of the movable mold 222. Top and bottom ends of the gate 225 communicate with the cavity 25 and with the runner 26, respectively.

The ejector mechanism 24 includes a first ejector retention plate 241, a second ejector retention plate 242, a knockout pin 243, a gate pin 244, and a runner pin 245. The first ejector retention plate 241 defines a sliding slot 246. The ejector mechanism 24 further includes a slider 247 slidably received in the sliding slot 246, and a plurality of fasteners 249. One end of the runner pin 245 is fixed to the first ejector retention plate 241 via one fastener 249, and an opposite end of the runner pin 245 extends towards the runner 26. One end of the gate pin 244 is fixed to the first ejector retention plate 241 via one fastener 249, and the other end of the gate pin 244 runs through the movable half 22 and extends towards the gate 225. One end of the knockout pin 243 hinges on the slider 247, and the other end of the knockout pin 243 runs through the movable half 22 and extends adjacent to the cavity 25 and the top end of the gate 225. The gate pin 244 and the runner pin 245 are substantially parallel to a moving direction of the movable half 22. The knockout pin 243 is oblique to the gate pin 244. In the illustrated embodiment, an angle defined between the knockout pin 243 and the gate pin 244 is α. The knockout pin 243 includes a trimming edge 248 adjacent to the top end of the gate 225. More particularly, a top face of the knockout pin 243 including an end thereof at the trimming edge 248 is coplanar with the second cavity surface 223. The trimming edge 248 abuts a junction where the second cavity surface 223 adjoins a left-hand sidewall of the gate 225. In the illustrated embodiment, such junction is also an edge.

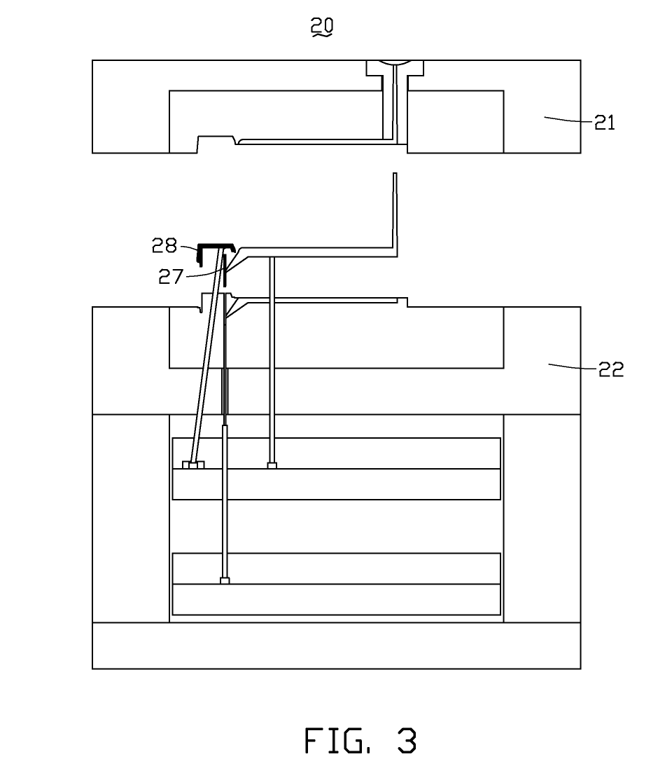

Referring also to FIG. 3, in use, the injection mold 20 is clamped and molten material is injected into the injection system 213. The molten material flows through the runner 26, the gate 225, and fills the cavity 25. The molten material is cooled to solidify, thus forming a product 28. The product 28 is connected to excess material 27 formed in the gate 225.

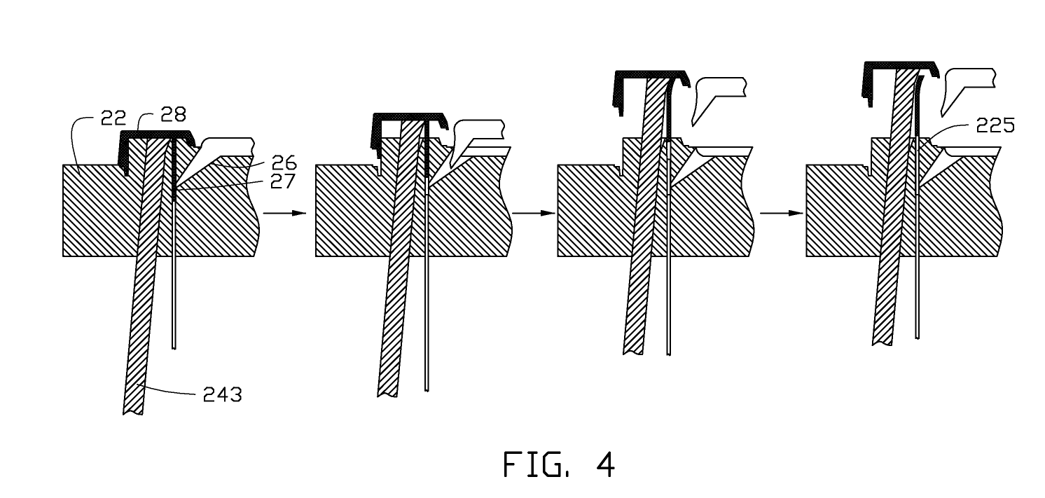

Referring also to FIG. 4, the movable half 22 is moved to separate from the fixed half 21. Then the ejector mechanism 24 ejects the product 28 from the movable half 22. In detail, the first ejector retention plate 241 moves upward, and the slider 247 slides horizontally along the sliding slot 246 while the knockout pin 243 gradually moves upward. The second ejector retention plate 242 drives the gate pin 244 after the first ejector retention plate 241 drives the knockout pin 243. A moving direction of the product 28 relative to the knockout pin 243 is oblique, because the knockout pin 243 is oblique to the moving direction of the movable half 22. Therefore, during such moving, the trimming edge 248 cuts the excess material 27 from the product 28. To obtain maximum quality, the angle α is about 10° to about 30°, and preferably about 15°.

In detail, after the movable half 22 is separated from the fixed half 21, the first ejector retention plate 241 drives the knockout pin 243 and the runner pin 245. The runner pin 245 biases solidified material in the runner 26 from the product 28 and the movable mold 222. The angled movement of the knockout pin 243 gradually moves the trimming edge 248 to a root of the excess material 27, which is finally cut from the product 28 accordingly. During movement of the knockout pin 243, the sliding slot 246 allows the slider 247 to slide therein. The second ejector retention plate 242 moves the gate pin 244 to completely eject the excess material 27 from the gate 225.

The injection mold 20 with the trimming edge 248 trims the excess material 27 from the product 28 during release of the product 28 from the injection mold 20. Accordingly, the process is simplified, the manufacturing time is shortened, and manpower and costs are reduced. Consequently, manufacturing efficiency is improved. In addition, the trimmed surface of the product 28 is smooth, improving the final quality of the product 28.

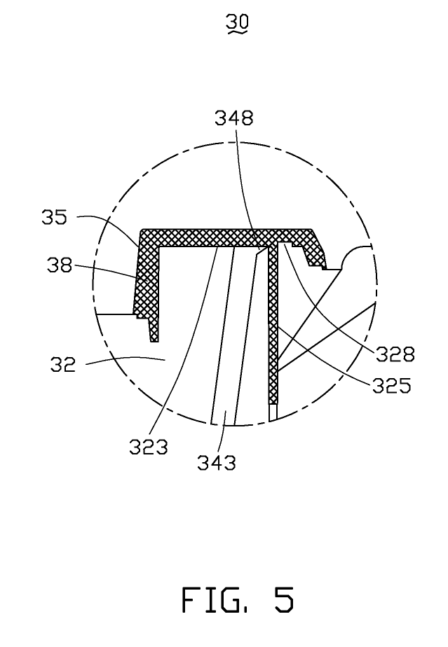

Referring to FIG. 5, a second embodiment of an injection mold 30 is shown. The injection mold 30 differs from the injection mold 20 of the first embodiment only in that a second cavity surface 323 of a movable half 32 includes a protrusion 328, which protrudes into a cavity 35. The protrusion 328 is directly adjacent to a top end of a gate 325. In particular, a left-hand side face of the protrusion 328 is integrally coplanar with a right-hand sidewall of the gate 325. The protrusion 328 and a knockout pin 343 are at opposite sides of the gate 325. The knockout pin 343 includes a trimming edge 348.

Since the second cavity surface 323 includes the protrusion 328, a product 38 formed in the cavity includes a depression (not labeled) adjacent to the gate 325. When the trimming edge 348 trims excess material formed in the gate 325 from the product 38, an end of the excess material is extruded into the depression, and resistance exerted on the trimming edge 348 during trimming is reduced. Therefore trimming the excess material is easier, a trimmed surface of the product 38 is smoother, and a working lifetime of the trimming edge 348 is longer.

Alternatively, the injection mold 20 (or 30) may include more than one gate 225 (or 325) and more than one knockout pin 243 (or 343). In other alternative embodiments, the first ejector retention plate 241 may omit the slider 247. In such cases, a bottom end of the knockout pin 243 slides horizontally in the sliding slot 246.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. An injection mold, comprising:
a movable half comprising:
a gate being a channel having an opening;
a first cavity surface adjoining the gate at the opening thereof, and
a knockout pin oblique to a moving direction of the movable half, wherein the knockout pin extends towards the first cavity surface and adjacent to the opening of the gate, and the knockout pin comprises a trimming edge coplanar with the opening of the gate and the first cavity surface.

2. The injection mold of claim 1, wherein the first cavity surface comprises a protrusion; and the trimming edge and the protrusion are at opposite sides of the gate.

3. The injection mold of claim 1, further comprising a first ejector retention plate.

4. The injection mold of claim 3, wherein the first ejector retention plate defines a sliding slot in which a bottom end of the knockout pin is slidable, and an opposite top end of the knockout pin is coplanar with the opening of the gate and the first cavity surface.

5. The injection mold of claim 4, further comprising a slider slidably received in the sliding slot, wherein the bottom end of the knockout pin is fixed to the slider.

6. The injection mold of claim 5, further comprising a second ejector retention plate and a gate pin; wherein one end of the gate pin is fixed on the second ejector retention plate, an opposite end of the gate pin extends towards the gate, and the second ejector retention plate is configured for driving the gate pin.

7. The injection mold of claim 6, wherein the second ejector retention plate drives the gate pin after the first ejector retention plate drives the knockout pin.

8. The injection mold of claim 1, wherein an angle defined by the knockout pin and the moving direction of the movable half is in the range from about 10° to about 30°.

9. The injection mold of claim 1, wherein an angle defined by the knockout pin and the moving direction of the movable half is about 15°.

10. An injection mold, comprising:
a movable half comprising a gate;
a fixed half, wherein the fixed half and the movable half cooperatively form a cavity when the fixed half and the movable half are clamped together, the cavity communicating with the gate; and
an ejector mechanism comprising a knockout pin oblique to a moving direction of the movable half, wherein the knockout pin extends to a junction where the cavity communicates with the gate, and the knockout pin comprises a trimming edge at the junction where the cavity communicates with the gate.

11. The injection mold of claim 10, wherein the knockout pin comprises a trimming edge at the end adjacent to the gate and the cavity to separate excess material from the product.

12. The injection mold of claim 10, wherein the first cavity surface comprises a protrusion; and the trimming edge and the protrusion are at opposite sides of the gate.

13. The injection mold of claim 10, wherein the ejector mechanism further comprises a first ejector retention plate to move the knockout pin.

14. The injection mold of claim 13, wherein the first ejector retention plate defines a sliding slot in which an end of the knockout pin is slidable, and an opposite end of the knockout pin is coplanar with the first cavity surface.

15. The injection mold of claim 14, wherein the ejector mechanism further comprises a second ejector retention plate driving a gate pin; one end of which is fixed on the second ejector retention plate, and an opposite end of which extends towards the gate.

16. The injection mold of claim 15, wherein the second ejector retention plate moves the gate pin after the first ejector retention plate moves the knockout pin.

17. The injection mold of claim 10, wherein an angle defined by the knockout pin and the moving direction of the movable half is about 10° to 30°.

18. The injection mold of claim 10, wherein an angle defined by the knockout pin and the moving direction of the movable half is 15°.

19. The injection mold of claim 10, wherein the movable half comprises a first runner surface; the fixed half comprises an injection system communicating with an outside of the injection mold and a second runner surface; and the first runner surface and the second runner surface cooperatively forming a runner communicating with the cavity and the injection system when the fixed half and the movable half are clamped together.
